(19) United States
(12) Patent Application Publication
(10) Pub. No.: US 2012/0221795 A1
(43) Pub. Date: Aug. 30, 2012

(54) SHARED MEMORY SYSTEM AND CONTROL METHOD THEREFOR

(75) Inventors: Masahiro HOSHAKU, Tokyo (JP); Yukiteru Murao, Kanagawa (JP); Daisuke Horigome, Kanagawa (JP); Masanori Okinoi, Kanagawa (JP)

(73) Assignee: PANASONIC CORPORATION, Osaka (JP)

(21) Appl. No.: 13/467,684

(22) Filed: May 9, 2012

Related U.S. Application Data
(63) Continuation of application No. PCT/JP2011/002296, filed on Apr. 19, 2011.

(30) Foreign Application Priority Data
Jul. 16, 2010 (JP) 2010-161797

(51) Int. Cl. G06F 12/00; G06F 12/08

(52) U.S. Cl. 711/130; 711/147; 711/E12.001; 711/E12.038

(57) ABSTRACT

A shared memory system provides an access monitoring mechanism 112 with a definition for taking clusters for motion picture attributes as pieces of cluster memory 1 and 2. When a DSP (2) 104 makes access to memory while adding attribute information about an image to the access, the access monitoring mechanism 112 outputs to a cluster memory space selector 119 control information 131 that permits making of access to the pieces of cluster memory 1 and 2. Based on the control information 131, the cluster memory space selector 119 sorts access from the DSP (2) 104 to the cluster memory 1 or 2. The same also applies to access from a GPU 105. A plurality of master processors share shared memory 110 divided into a plurality of clusters 111, thereby holding coherence of cache memory.

### BACKGROUND

1. Field of the Invention

The present invention relates to a shared memory system having shared memory accessed by a plurality of master processors and to a control method therefor.

2. Description of the Related Art

In a known shared memory system, a memory is shared among a plurality of processors. FIG. 11 is a block diagram showing a configuration of the known shared memory system. A CPU (1) 2101, a CPU (2) 2102, a DSP (1) 2103, a DSP(2) 2104, a GPU 2105, an HWA (1) 2106, and an HWA (2) 2107 share a main storage memory 2151 by an interconnect bus 2219.

A specific example provides a case where decoding of a motion picture stream is performed. During processing, data to be processed is first fetched from the main storage memory 2151 by use of the CPU (1) 2101, and processing, like a header analysis, is carried out. Next, a motion picture is subjected to coding processing by use of the DSP (2) 2104, and subsequently, the frame data are shared by means of the main storage memory 2151, whereby the picture is output to an LCD, or the like, by use of the HWA(1) 2106.

Another example is a known shared memory system described in Patent Document 1. FIG. 12 is a block diagram showing a configuration shown in Patent Document 1. The shared memory system detects a load of an interconnect bus 3319 by a bus load detection section 3340. Bus load information 3341 is reported to a replacement way control section 3350. The replacement way control section 3350 changes the replacement technique based on a preset requisite for determining a bus load.

Even when there is an apprehension about occurrence of a possible local increase in bus traffic, it becomes possible to make the bus traffic uniform. Therefore, this makes it possible to provide a master processor requiring real-time processing with guaranteed performance.

Patent Document 1: JP-A-2006-119796

### SUMMARY

However, the above-described shared memory system encounters the following problems. In the example shown in FIG. 11, the respective master processors share data by use of the main storage memory 2151. The main storage memory 2151 is generally made up of DRAM which requires a longer latency time than that required by built-in memory of an LSI. Therefore, a bus access to the main storage memory 2151 results in a bottleneck in the configuration, which poses difficulty in sufficiently exhibiting performance of each of the master processors.

Moreover, since a replacement way for cache memory is controlled based on the bus load information 3341 in the configuration described in connection with Patent Document 1 shown in FIG. 12, bus traffic for main storage memory 3351 can be made uniform. Specifically, when the bus load is heavy, replacement processing entailing a small bus load is performed. In the meantime, when the bus load is light, replacement processing entailing a heavy bus load is performed. Thus, the bus can be effectively used, to thus make it possible to improve local bus traffic and make the bus traffic uniform.

However, under the method, system performance surpassing a bas band of the main storage memory 3351 cannot be exhibited. It is hard to make full use of potential performance of the master processors, such as a CPU 3301, a CPU 3302, and a DSP (1) 3303. Moreover, in this case, the main storage memory 3351 keeps operating at all times, which may impair merchantability of a portable device particularly requested to reduce power consumption, or the like.

The present invention aims at providing a shared memory system capable of shortening a processing time and abating power consumption, as well as providing a control method therefor.

A shared memory system of the present invention includes a plurality of master processors; a shared memory accessed by the plurality of master processors and divided into a plurality of clusters; an assignment section that assigns access from the master processors to a plurality of cluster spaces, the cluster spaces each including at least one of the plurality of clusters and configured of any one of a space shared among all of the master processors, a space shared among a plurality of specific master processors, and a space occupied by a single master processor; and an alteration section that alters configuration of the cluster spaces based on an attribute information about the plurality of master processors. It thereby becomes possible to enhance processing performance of the master processors, to thus shorten a processing time. Moreover, access to external main storage memory is curtailed, thereby abating power consumption.

In the shared memory system of the present invention, each of the master processors may include a central processor, a digital signal processor, a general purpose graphics processor, or a hardware accelerator.

In the shared memory system of the present invention, the attribute information may be added to an access signal from each of the master processors and includes at least one of a master identification attribute, a read/write attribute, an address attribute, a data/command attribute, a secure attribute, a cache/non-cache attribute, and a transfer attribute.

In the shared memory system of the present invention, the shared memory may include a cache memory. The shared memory system may further include a clock control section that, when a mishit has occurred in one of the cluster spaces, decreases an operation clock frequency of a master processor for which access is assigned to the one of the cluster spaces during refilling operation or halts the operation clock of the master processor.

The shared memory system of the present invention may further include an access monitoring section that determines attribute information about the master processor and that permits the master processors to make access to the cluster spaces. Coherence performance of the system can thereby be enhanced.

The shared memory system of the present invention may further include a scheduling section that stores accesses to the cluster spaces from the master processors; and an access policy control section that controls the accesses to the cluster spaces stored by the scheduling section; wherein the access monitoring section determines the attribute information about the master processors and passes the attribute information to the scheduling section, and the access policy control section notifies a policy to the scheduling section and permits making of access to a cluster space corresponding to the attribute information. On the occasion of making of access to the cluster space, the policy can be reflected on the access.

In the shared memory system of the present invention, the access policy control section may change a content of a priority setting register on which a priority level of access to the cluster space is set. Coherence performance of the system can thereby be enhanced.

The shared memory system of the present invention may further include an integration section that integrates the accesses from the master processors to the cluster spaces that have been stored by the scheduling section. Cluster spaces exhibiting high sharing characteristics can thereby be integrated, so that coherence performance of the system can be enhanced.

In the shared memory system of the present invention, the attribute information added to an access signal from each of the master processors may include a master identification attribute, a read/write attribute, an address attribute, a data/command attribute, a secure attribute, a cache/non-cache attribute, and a transfer attribute.

In the shared memory system of the present invention, the shared memory may include a cache memory. The shared memory system may further include an urgent transfer attribute addition section that adds an urgent transfer attribute to access from the master processor to the cluster space. Further, the access policy control section lends an area of the cluster space, which can be given up, to the access from the master processor having the added urgent transfer attribute. Cluster space can thereby be assigned even to a master processor that performs processing which is highly urgent but has a low priority level.

In the shared memory system of the present invention, when the access from the master processor having the added urgent transfer attribute completes, the cluster space with the lent area may be restored to an original state. The cluster space can thereby be restored to its state achieved before urgent transfer.

In the shared memory system of the present invention, the shared memory may include a cache memory, and the plurality of cluster spaces may be configured of cluster spaces having different line sizes. Further, the shared memory system includes a line size control section that sorts the access from each of the master processors to the cluster space having a line size commensurate with a content of processing of the master processor. Access can thereby be sorted into cluster space having a line size commensurate with a content of master processing.

The shared memory system of the present invention may further include a power control section that blocks a power supply to a specific cluster space or that hinders a leakage current. Power performance can thereby be enhanced.

The shared memory system of the present invention may be configured of a semiconductor device and connected to another semiconductor device as the master processor. Processing performance of the entire system can be enhanced, so that the number of pieces of main storage memory connected to another semiconductor device can be curtailed.

A shared memory system control method for a shared memory system having a plurality of master processors and a shared memory that is accessed by the plurality of master processors and that are divided into a plurality of clusters, the method comprising:

an assignment step of assigning access from the master processors to the cluster spaces, the cluster spaces each including at least one of the plurality of clusters and configured any one of a space shared among all of the master processors, a space shared among a plurality of specific master processors, and a space occupied by a single master processor;

an alteration step of altering configuration of the cluster spaces based on attribute information about the master processors.

The present invention enables enhancement of processing performance of a master processor, thereby shortening a processing time. Further, the number of accesses to external main storage memory is curtailed, thereby diminishing power consumption.

For instance, using a multiprocessor having a shared memory system makes it possible to implement a high performance multiprocessor involving consumption of a shortened processor processing time. Moreover, the number of accesses to external work memory (main storage memory) is curtailed, whereby power consumed by an application processor used in a battery-powered portable electronic device can be significantly reduced.

### BRIEF DESCRIPTION OF THE DRAWINGS

FIG. 1 shows a schematic diagram showing a configuration of a shared memory system of a first embodiment.

FIG. 2 shows a flowchart showing operation procedures of memory access control.

FIG. 3 shows an example flowchart showing procedures for updating settings of cluster memory space.

FIG. 4 shows a table showing an example setting of an access policy control mechanism 114.

FIG. 5(A) shows a table showing example-setting of a master identification attribute 1040, and FIG. 5(B) shows a table showing example settings of a cache attribute 1090.

FIG. 6 shows a flowchart showing motion picture playback operation procedures.

FIG. 7 shows a schematic showing a configuration of a shared memory system of a second embodiment.

FIG. 8 shows a schematic showing a configuration of a shared memory system of a third embodiment.

FIG. 9 shows a schematic showing a configuration of a shared memory system of a fourth embodiment.

FIG. 10 shows a schematic showing a configuration of a shared memory system of a fifth embodiment.

FIG. 11 shows a block diagram showing a configuration of a related art shared memory system.

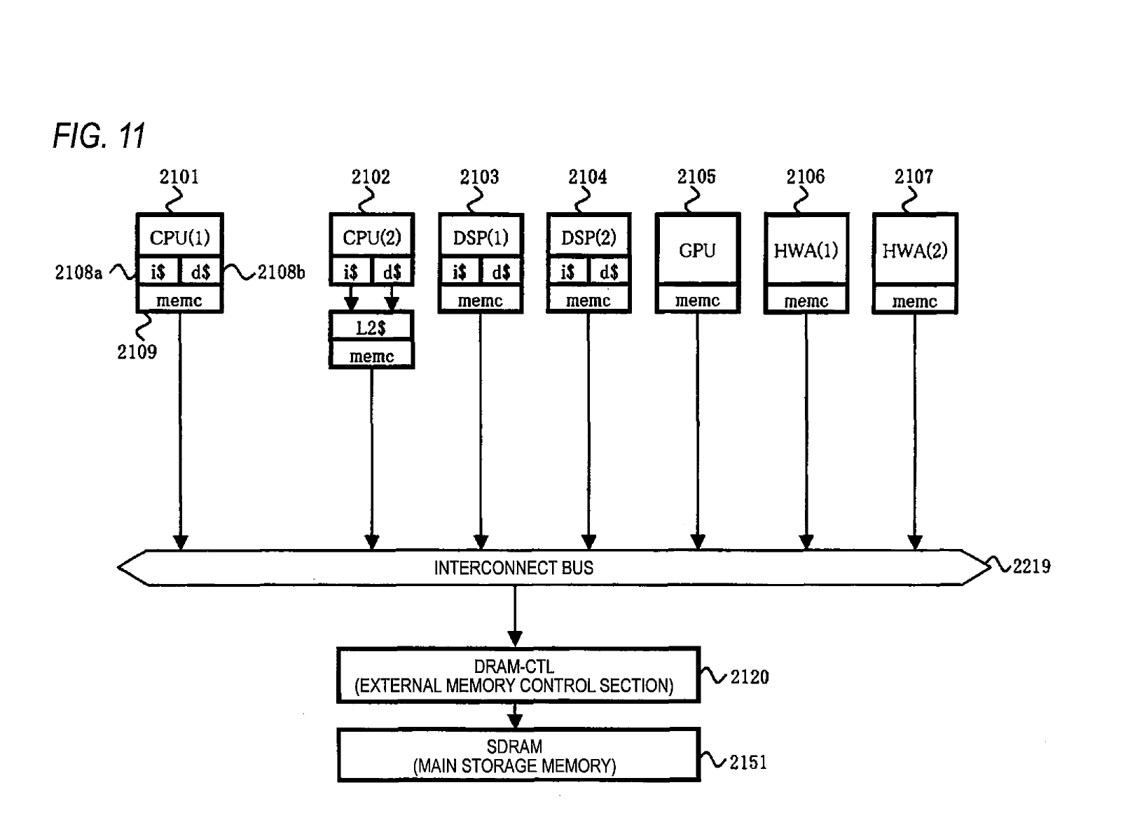

FIG. 12 shows a block diagram showing a configuration described in connection with Patent Document 1.

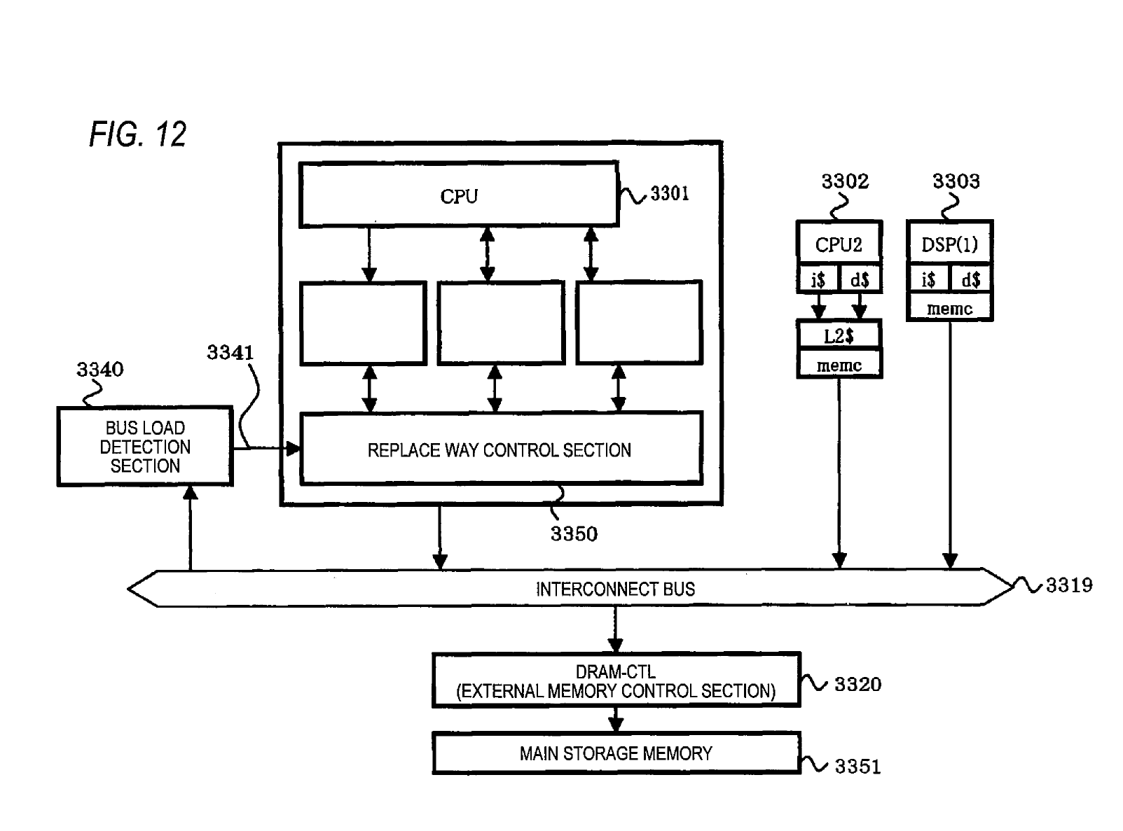

### DETAILED DESCRIPTION

Embodiments of a shared memory system of the present invention and a control method therefor are described by reference to the drawings. A shared memory system of each of embodiments will be described below. The shared memory system has a cache memory that acts as a shared memory accessed by a plurality of master processors, such as an asymmetric multiprocessor and a symmetric multiprocessor.

### First Embodiment

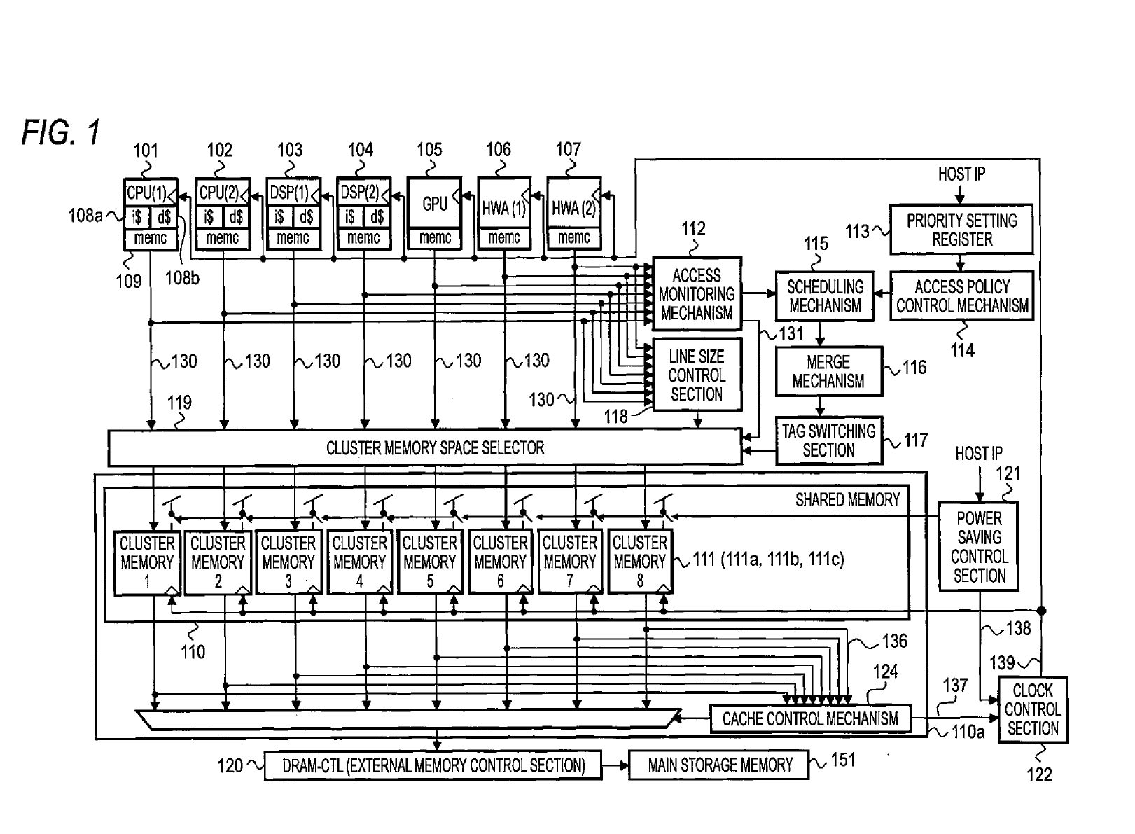

FIG. 1 shows a schematic diagram showing a configuration of a shared memory system of a first embodiment. The shared memory system has seven master processors: namely, a CPU (Central Processing Unit) (1) 101, a CPU (2) 102, a DSP (Digital Signal Processor) (1) 103, a DSP (2) 104, a GPU (General Purpose Graphics Processing Unit) 105, an HWA (Hardware Accelerator) (1) 106, and an HWA (Hardware Accelerator) (2) 107.

The seven master processors share a shared memory (cache memory) 110 divided into eight clusters of memory (clusters) 111, by a cluster memory space selector 119. The first processor [the CPU (1) 101] and the second processor [the CPU (2) 102] configure an asymmetric multiprocessor. Further, the third processor [the DSP (1) 103] and the fourth processor [the DSP (2) 104] configure an asymmetric multiprocessor.

When accessing the shared memory 110 as cache memory, each of the master processors outputs a bus access signal 130 additionally provided with attribute information along with an access destination address.

An access monitoring mechanism 112 passes control information 131 showing access permission to the cluster memory space selector 119 based on attribute information issued by each of the master processors. The cluster memory space selector 119 controls access from each of the master processors to each of the clusters 111 based on the control information 113 that shows access permission.

If a cache mishit occurred in a cluster memory space (a cluster space) shared by specific attribute information and when the clusters 111 are subjected to refill operation for this reason, a cache control mechanism 124 outputs, in the course of refill operation, to a clock control section 122 a flag signal 137 that enables lowering of an operation clock frequency of a master processor of interest or a halt of operation clock.

Upon receipt of, from the cache control mechanism 124, the flag signal 137 that enables lowering of the operation clock frequency or the halt of operation clock, the clock control section 122 halts an operation clock 139 of the master processor determined to remain stalled or decreases the operation clock frequency of the master processor. Operation of the clock control section 122 is controlled by a control signal 138 from a power saving control section 121.

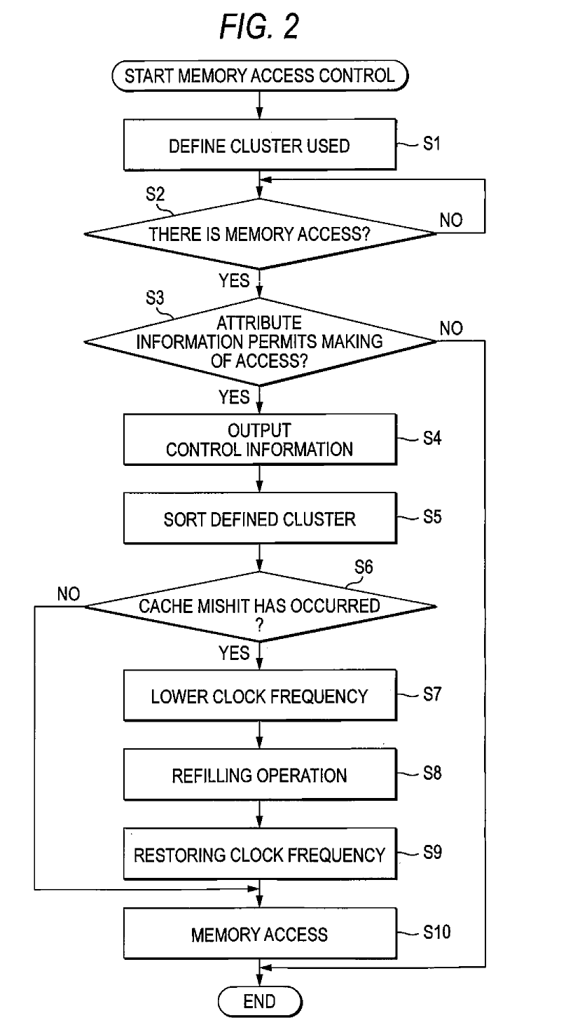

There is illustrated operation of the shared memory system having the above-mentioned configuration. FIG. 2 shows a flowchart showing operation procedures of memory access control. For instance, an explanation is now given to a case where the DSP (2) 104 acts as a video decode processing processor and where the GPU 105 uses the video data decoded (decrypted) by the DSP (2) 104 as input data for use in performing high picture quality processing.

First, the shared memory system provides the access monitoring mechanism 112 with a definition stating that a cluster with a motion picture attribute is previously taken as cluster memory 1 and cluster memory 2 (step S1).

When the DSP (2) 104 makes access to the memory with addition of attribute information about an image (step S2), the access monitoring mechanism 112 determines whether or not the attribute information added to the bus access signal 130 allows making of access (step S3). When the attribute information does not enable making of access, operation ends.

In the meantime, when the attribute information enables making of access, the access monitoring mechanism 112 outputs to the cluster memory space selector 119 the control information 131 that shows access permission to the cluster memory 1 and the cluster memory 2 (step S4).

Based on the control information 131 showing the access permission, the cluster memory space selector 119 sorts access from the DSP (2) 104 to either the cluster memory 1 or the cluster memory 2 (step S5). Likewise, when the CPU 105 implements access to the memory with addition of attribute information about the image, the memory access form the GPU 105 is also assigned to the cluster memory 1 and the cluster memory 2.

As mentioned above, the shared memory 110 split into the plurality of clusters 111 is shared among the plurality of master processors, coherence of the cache memory can be easily maintained. Further, when another master processor; for instance, the DSP (1) 103, adds different attribute information, memory access from the master processor other than the DSP (2) 104 and the GPU 105 can be eliminated.

In addition, during operation of the GPU 105, the cache control mechanism 124 determines whether or not a cache mishit has occurred (step S6). When the cache mishit took place, there is performed refilling operation (permutation operation) for refilling the clusters 111 from main storage memory 151 having great latency, or the like. At this time, since the GPU 105 remains stalled before receiving desired data, the cache control mechanism 124 detects the cache mishit made during memory access of the GPU 105 and the stalled state of the GPU 105 and then outputs to the clock control section 122 the flag signal 137 that enables lowering of the clock frequency of the GPU 105 (step S7). As mentioned above, the clock can also be halted in place of lowering of the clock frequency.

Upon receipt of the flag signal 137 that enables lowering of the clock frequency, the clock control section 122 lowers the clock frequency of the GPU 105 to a frequency that is lower than a clock frequency for normal operation and feeds the thus-lowered clock frequency to the GPU 105. The cache control mechanism 124 replaces the cluster (cache memory) 111 with desired data through permutation (step S8) and withdraws the flag signal 137 after permutation operation (refilling operation).

As a result of withdrawal of the flag signal 137, the clock control section 122 switches the clock frequency of the master operation clock 139 fed to the GPU 105 to a normal clock frequency, to thus restore the clock frequency to its original frequency (step S9). The GPU 105 makes memory access to the cluster memory 1 or the cluster memory 2 after refilling operation (step S10). Subsequently, the operation ends.

As mentioned above, the shared memory system of the present embodiment makes it possible to easily keep coherence of the data in the cluster memory shared among the master processors. Moreover, processing performance of the processor can be enhanced by decreasing system latency or the number of times access made to the main storage memory 151 by way of the external memory control section 120.

Moreover, since local increase of the cache hit rate can also be enabled, the number of times access made to a lower hierarchical layer of the memory is diminished, or a significant amount of power consumption can be reduced by dynamically halting the clock of the master processor remaining stalled or lowering the frequency of the clock.

The present embodiment has exemplified a case where the master processors are provided in number of seven and where the clusters are provided in number of eight. However, the master processors and the clusters are not particularly limited to these numbers and can be set in arbitrary numbers.

Setting of cluster memory space is now described. The cluster memory space is divided into space 111a shared among all of the master processors, space 111b shared solely among the plurality of master processors, and space 111c occupied by a single master processor.

The access monitoring mechanism 112 supervises the bus access signal 130 between the master processors 101 to 107 and the cluster memory space selector 119, thereby extracting attribute information. Contents on the attribute information are described in detail later.

The access monitoring mechanism 112 compiles attribute information for each memory access and passes the thus-compiled information to a scheduling mechanism 115. The scheduling mechanism 115 has a queuing mechanism and determines a sequence of storage of queues based on a policy reported from an access policy control mechanism 114. The policy is determined by a circuit of the access policy control mechanism 114; is flexibly determined by software by way of a priority setting resistor 113; or is determined in both ways.

When the same or similar memory accesses are stored in a queue, a merge mechanism 116 has a function of integrating both pieces of attribute information. For instance, when address space of a memory access having a read attribute from an identical master processor includes address space of another memory access, the merge mechanism 116 discards attribute information about the included memory access, selects attribute information about the memory access that includes the other memory access, and replaces either queue closer to the front row with the thus-selected attribute information.

The merge mechanism 116 holds setting information about the cluster memory space selector 119 and has a function of determining, from the attribute information integrated into the queue by the scheduling mechanism 115, whether or not to update settings of cluster memory space by way of a tag switching section 117.

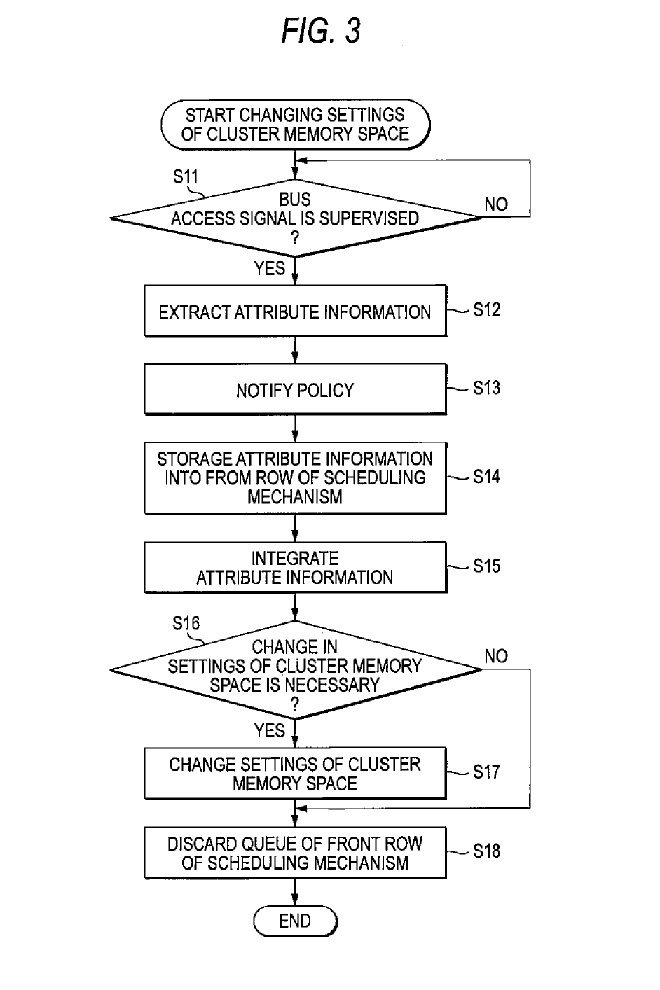

FIG. 3 is an example flowchart showing procedures for updating settings of cluster memory space. For instance, one line of LCD display data generated by the GPU 105 is stored as a write into the main storage memory 151 and in the form of cache data into space (equivalent to one line from 0×4000_{—}0000) of the cluster memory 5 of the shared memory 110.

When the HWA (2) 107 is taken as an LCD controller, the access monitoring mechanism 112 supervises the bus access signal 130 from the HWA (2) 107 (step S11).

As a result of having supervised the bus access signal 130, the access monitoring mechanism 112 extracts attribute information showing that a master identification attribute is the HWA (2) 107; that a read/write attribute is a read attribute; that a start address is 0×4000_{—}0000; and that a transfer size is one line of an LCD display (step S12). The thus-extracted attribute information is passed to the scheduling mechanism 115.

When a priority of access from the HWA (2) 107 is previously set, in the priority setting register 113, as being first among accesses from the master processors by means of software, the access policy control mechanism 114 reflects the policy stored in the access policy control mechanism 114 and reports the policy to the scheduling mechanism 115 (step S13).

Based on the policy, the scheduling mechanism 115 stores the attribute information about the HWA (2) 107 into the front row of the queue (step S14).

The merge mechanism 116 analyzes similarities of the attribute information stored in the queue of the scheduling mechanism 115 and integrates the attribute information (step S15). When determined, from setting information about the cluster memory space selector 119, that the space of the cluster memory 5 includes a read address, the merge mechanism 116 holds settings of space control of the cluster memory 5 of the shared memory 110 without being affected by attribute information about another memory access, thereby guaranteeing a cache hit of the HWA (2) 107.

When cluster memory suitable for attribute information (a read attribute, a write attribute, a start address, and a transfer size in the embodiment) is not assured on the occasion of write access first made by the GPU 105, settings for assuring space of the cluster memory 5 of the shared memory 110 is reflected on the cluster memory space selector 119.

The merge mechanism 116 holds the thus-set information and uses the setting information to determine whether or not an update is required on the occasion of subsequent memory accesses. Specifically, based on the setting information, the merge mechanism 116 identifies whether or not the settings of the cluster memory space must be changed (step S16). When necessary, the merge mechanism 116 changes the settings of the cluster memory space (step S17). When unnecessary, the merge mechanism 116 keeps the settings intact.

When determining similarities of the attributes, the merge mechanism 116 determines settings of cluster memory space based on a current read attribute, a write attribute, a start address, and a transfer size. In addition, all of the pieces of attribute information that can be extracted by the access monitoring mechanism 112, such as a master identification attribute and a command/data attribute, turn into determination information.

Subsequently, the scheduling mechanism 115 discards the attribute information stored in the front row of the queue (step S17). Operation thus ends.

The shared memory system of the present embodiment can thereby accomplish power saving attributable to ensuring of a sharing characteristic and reduction of refilling operation.

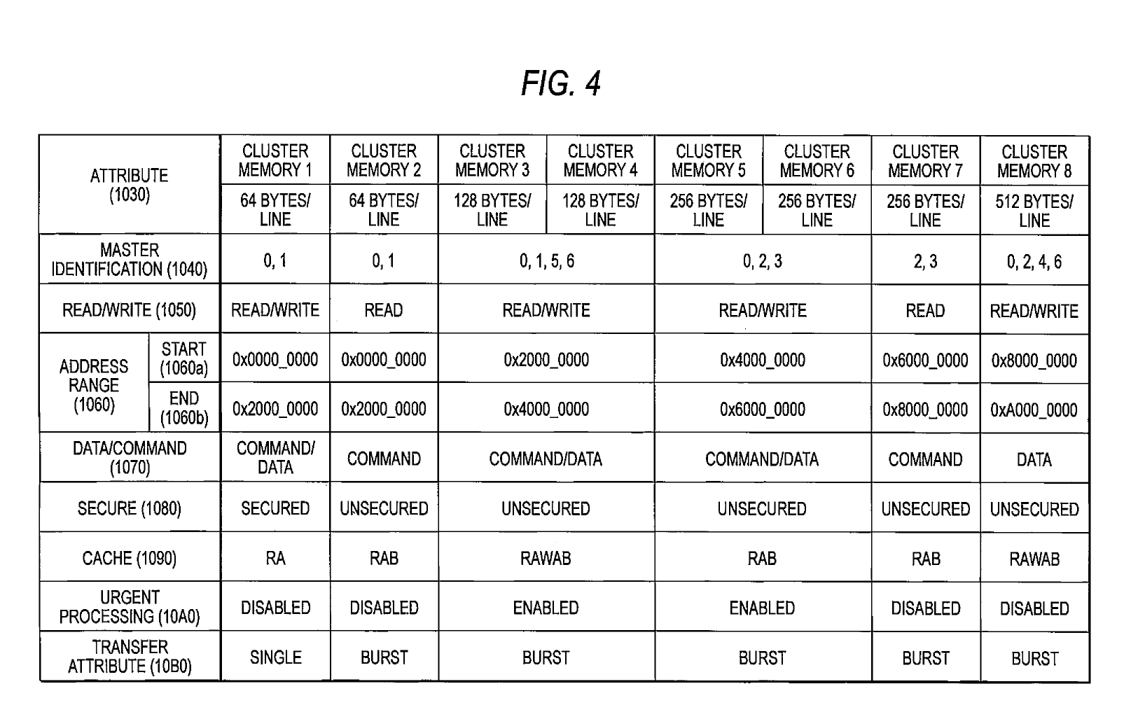

Attribute information is now described. FIG. 4 is a table showing an example setting of the access policy control mechanism 114. As indicated by the example setting of the access policy control mechanism 114, the shared memory system controls shared attributes of the pieces of cluster memory 1 to 8 by means of an attribute 1030 imparted when the master processors 101 to 107 make accesses to an interconnect bus.

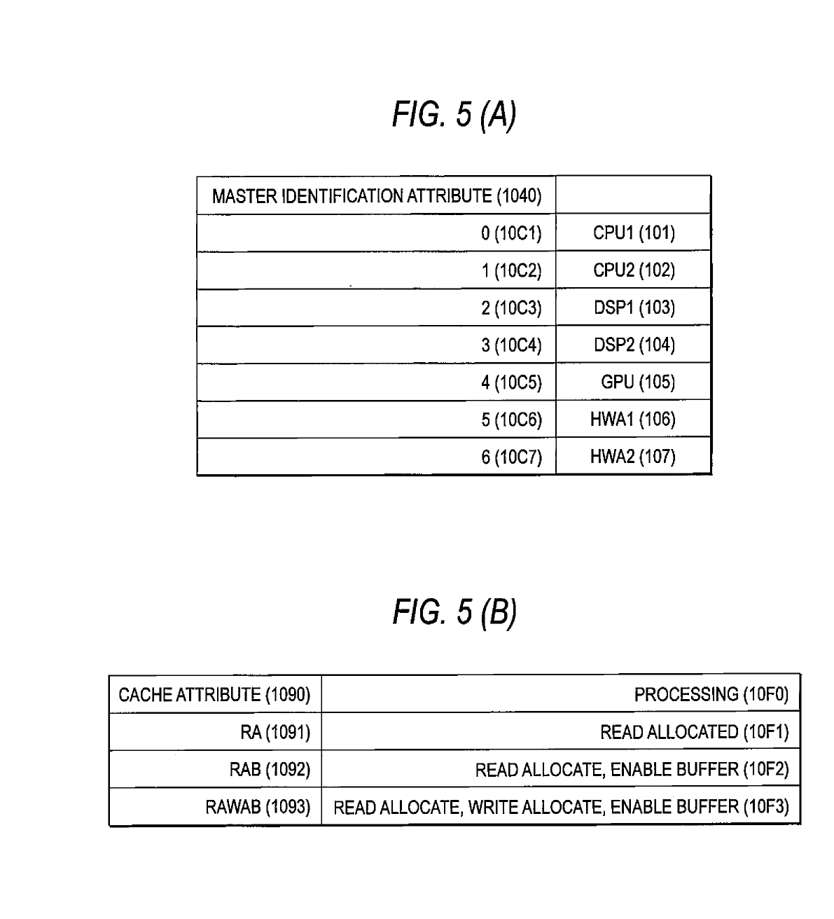

FIGS. 5(A) and (B) are tables showing example settings of a master identifying attribute 1040 and example settings of a cache attribute 1090. FIG. 5(A) shows the master identification attribute 1040, and FIG. 5(B) shows the cache attribute 1090.

Example settings of the cluster memory 1 are as follows. The attribute 1030 has a line size of 64 bytes per line. The master identification attribute 1040 includes 0 and 1. The read/write attribute 1050 shows both the case of a read attribute and the case of a write attribute. An address range (an address attribute) 1060 includes a start address 1060a of 0×00000000 or more and an end address 1060b of less than 0×20000000.

A data/command attribute 1070 is command/data. A secure attribute 1080 represents a secure state. A cache attribute (cache/non-cache attribute) 1090 is Read Allocate. An urgent processing attribute 10A0 is disabled. A transfer attribute (10B0) shows that the cluster memory 1 can share command/data between the CPU (1) 101 and the CPU (2) 102 when the transfer attribute is single.

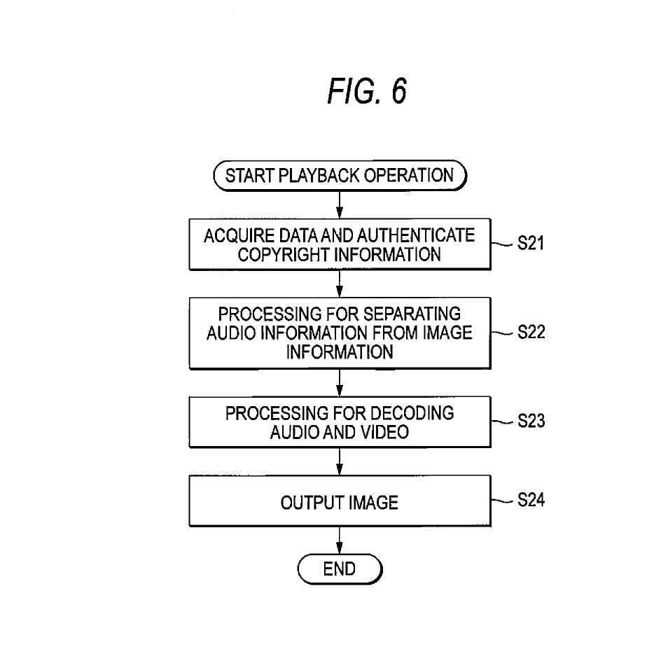

An explanation is now given by taking as example, for instance, a case where a portable device plays back a motion picture. FIG. 6 is a flowchart showing motion picture playback operation procedures. First, the CPU (1) 101 acquires data and authenticates copyright information (step S21). Specifically, the CPU (1) 101 performs processing for acquiring stream data from the main storage memory 151 and authenticating protective information, like copyright information. On that occasion, the CPU (1) 101 makes access by means of the attribute 1030 and shares data processed by the cluster memory 1.

The CPU (2) 102 performs processing for separating audio information from image information (step S22). Specifically, the CPU (2) 102 performs processing for separating audio information from image information with regard to the data subjected to authentication processing. Separated data are shared between the pieces of cluster memory 5 and 6.

The DSP (1) 103 performs processing for decoding sound and an image (step S23). Specifically, when performing processing for decoding audio information, the DSP (1) 103 uses the data processed by the CPU (2) 102 and shared between the pieces of cluster memory 5 and 6. The DSP (1) 103 outputs the data subjected to sound decoding processing to a digital-to-analogue converter.

Further, when performing processing for decoding a motion picture stream to thereby convert the stream into frame data, the DSP (2) 104 uses the data shared between the pieces of cluster memory 5 and 6. The frame data subjected to motion picture decoding are shared by the HWA (2) 107 by use of the cluster memory 8.

The HWA (2) 107 performs processing for reading out the data shared by the cluster memory 8 and outputting the thus-read data on an LCD (not shown) (step S24). Subsequently, operation ends.

In steps S21 to S24, the data existing among the master processors are controlled and shared by means of the attribute 1030. Processing pertaining to steps S21 to S24 should be considered to be illustrative and not to be restrictive.

As mentioned, in the shared memory system of the first embodiment, the appropriate attribute 1030 is previously set, and some or all of the pieces of cluster memory 1 to 8 appropriately, dynamically, correspondingly share data based on the preset attribute 1030, so that system performance can be enhanced. Concurrently, since coherence is enhanced, the number of accesses to the main storage memory 151 can be reduced. Therefore, low power consumption performance indispensable for a portable device can also be enhanced.

In the attribute 1030, a line size per cluster memory can be 64 bytes per line; 128 bytes per line; 256 bytes per line; 512 bytes per line, or the like.

The master identification attribute 1040 can also be set by means of an arbitrary combination. For instance, memory can be shared by means of only 0 and 1; 0, 1, 5, and 6; 0, 2, and 3; 2 and 3; and only 5.

The address range 1060 can also be set to an arbitrary range, like a range from 0×00000000 to 0×20000000.

The data/command attribute 1070 may be set by means of command/data, only a command, only data, or the like. Although only one type of data attribute 1078 is provided, pluralities of data attributes are also available.

The secure attribute 1080 can also be set as a secure attribute or a non-secure attribute. The cache attribute 1090 can also be Read Allocate, Read Allocate Bufferable, Read Allocate Write Allocate Bufferable, or the like. The urgent processing attribute 10A0 can also be selected from a response-enabled attribute or a response-disabled attribute. The transfer attribute 10B0 can also be a single transfer attribute, a burst transfer attribute, or the like.

An access policy can also be controlled by combination of one or more of the attributes mentioned above or pieces of other attribute information.

### Second Embodiment

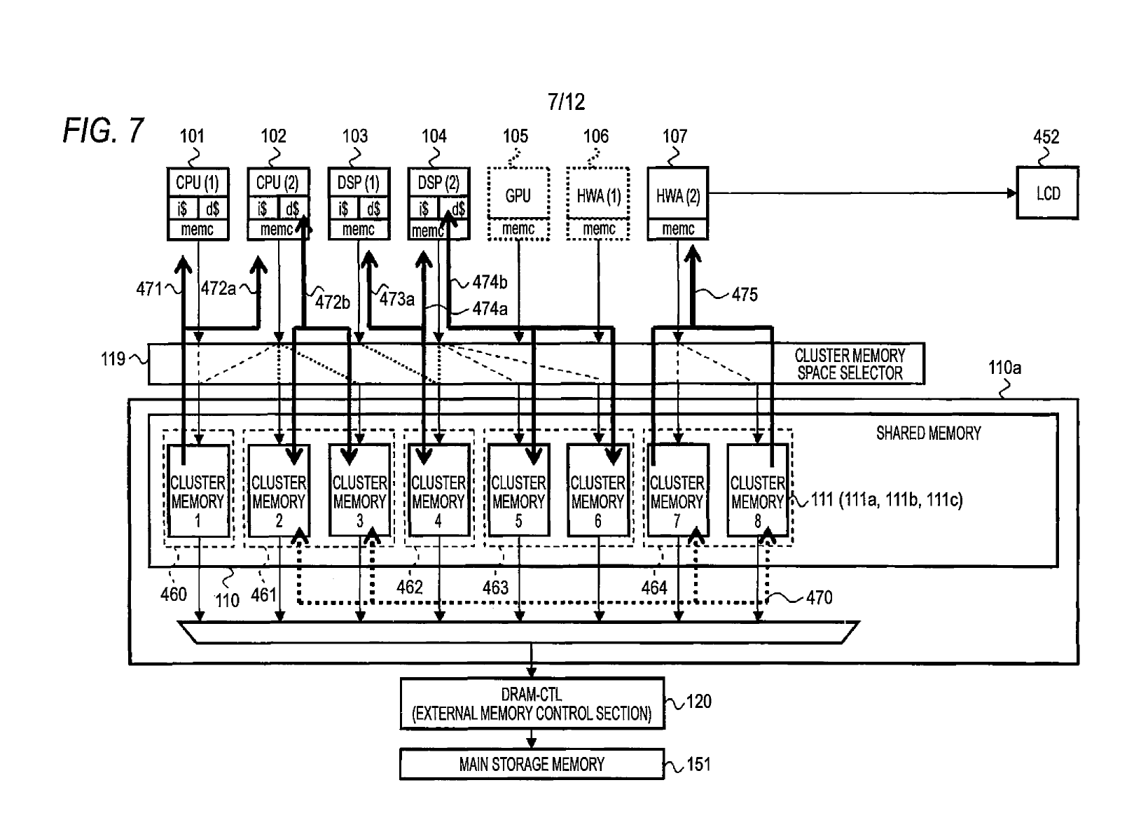

FIG. 7 is a schematic showing a configuration of a shared memory system of a second embodiment. In addition to including the function of the shared memory system described in connection with the first embodiment, the shared memory system of the second embodiment has a cache memory space lending function for memory access having an additional urgent transfer attribute.

Constituent elements that are the same as those described in connection with the first embodiment are assigned the same reference numerals, and hence their repeated explanations are omitted. In the present embodiment, the shared memory system is now described as having a shared cache memory configuration 110a.

An LCD (a liquid crystal display) 452 is connected to the HWA (2) 107. The cluster memory space selector 119 assigns the way corresponding to the cluster memory 1 as the shared clusters 111 for the CPU (1) 101 and the CPU (2) 102. Therefore, accesses to the pieces of cluster memory 111 include memory access 471 and memory access 472a.

Memory access 472b is made to a space to which the data cache attribute of the CPU (2) 102 is assigned (i.e., a shared space 461 made up of the pieces of cluster memory 2 and 3).

Memory access 473a made by the DSP (1) 103 and memory access 474a made in response to the data cache attribute of the DSP (2) 104 share a space 462 made up of the cluster memory 4. Memory access 474b made in response to the data cache attribute of the DSP (2) 104 is assigned a space 463 made up of the pieces of cluster memory 5 and 6.

Finally, the final image data displayed on the LCD 452 by the HWA (2) 107 are stored into a space 464 made up of pieces of cluster memory 7 and 8 by memory access 475 made by the HWA (2) 107.

In the meantime, animation, like a user interface (hereinafter abbreviated as “UI”) made by the CPU (2) 102, is stored in the space 461 made up of the pieces of cluster memory 2 and 3 after having undergone final image synthesis performed by the CPU (2) 102.

Coherence between the space 464 made up of the pieces of cluster memory 7 and 8 and the space 461 made up of the pieces of cluster memory 2 and 3 is maintained by an internally provided coherence function 470.

As mentioned above, the HWA (2) 107 makes memory access 475, whereby an output can be sent to the LCD 452 by means of the memory access 475 made to the space 464 made up of the pieces of cluster memory 7 and 8.

By means of taking the following operation as an example, the function of lending a cache memory space to the memory access given the urgent processing transfer attribute is now described. The operation is one during which the HWA (2) 107 is transferring output image data to the LCD when the CPU (1) 101 controls a connected peripheral device, when the CPU (2) 102 is controlling UI rendering of a display screen, when the DSP (1) 103 is performing acoustic processing, when the DSP (2) 104 is performing video decoding processing, and when the GPU 105 and the HWA (1) 106 (a DMA controller) remain inoperative.

In this operating state, the HWA (2) 107 outputs 60 frames per second. The HWA (2) 107 is a master processor that has to output final composite image data at a given period to the LCD 452 without a delay; namely, a so-called dead line guaranteed master processor on which there is imposed real time processing.

The video decoding DSP (2) 104 also must decode per second a predetermined number of images having a predetermined size and pass motion picture data to the HWA (2) 107 in a subsequent stage. Likewise, real-time processing is required.

When compared with video decode processing performed by the HWA (2) 107, video decode processing performed by the DSP (2) 104 is processing requiring large amounts of band width of the main storage memory 151. Therefore, throughput to the main storage memory 151 is given most preferentially.

The first DSP (1) 103 that takes charge of performing audio decoding processing also requires real-time processing. However, on the presumption that video processing is performed on a large high-definition screen, the main storage memory 151 requires a larger band width in sequence of DSP (2) 104>>HWA (2) 107>DSP (1) 103.

In such a case, the shared memory (cache memory) 110 is controlled, on a priority level proportional to a required band, so as to impart a greater cluster memory space to the master processor that requires a much larger band.

Therefore, a way making up the clusters 111 of the shared memory 110 is assigned a larger number of ways in sequence of DSP (2) 104>HWA (2) 107>DSP (1) 103.

In relation to a sharing degree, although both the DSP (2) 104 and the HWA (2) 107 handle video data, a sharing degree achieved by them is not so high. Further, since the DSP (1) 103 handles audio data, the data do not need to be shared between the DSP (1) 103 and another master processor. In the meantime, the DSP (1) 103 and the DSP (2) 104 can share a portion of a command.

Therefore, data cache of the DSP (1) 103, data cache of the DSP (2) 104, and data cache of the HWA (2) 107 are controlled in an unshared manner. A command for the DSP (1) 103 and a command for the DSP (2) 104 are stored in a shared area, where the commands are subjected to coherence control.

Computation is repeated by use of single data with regard to; for instance, data pertaining to the DSP (1) 103 and data pertaining to the DSP (2) 104. Assigning a portion of shared cache space as secondary cache of each of the DSPs is effective in view of enhancement of latency performance.

In the meantime, access to the main storage memory 151 of the CPU (1) 101 is random. Further, in the present embodiment, each of the DSP (2) 104, the HWA (2) 107, and the DSP (1) 103 exhibits a low degree of sharing data with respect to the CPU (1) 101, and core performance of the processor is not high. Consequently, the number of ways assigned to the CPU (1) 101 is not large, and the lowest priority level is set on the CPU in connection with control of access to the clusters.

The CPU (2) 102 controls the UI; combines a resultant video decoded by the DSP (2) 104 with animation of the UI generated by the CPU (2) 102; and passes frame data to the HWA (2) 107. The operations lead to assumption that the CPU (2) 102 have produced LCD display data by combination of the data from the DSP (2) 104 with the data from the HWA (2) 107 so that a sharing degree of the shared memory 110 will increase with high probability. Consequently, assignment of the clusters 111 is performed such that data existing among the master processors become sharable.

Further, a comparatively high sharing degree exists between the data from the CPU (2) 102 and the data from the CPU (1) 101 that processes information from an external device. The CPU (1) 101 processes information acquired by means of an external device; for instance, a touch panel of an LCD. Upon receipt of a processing result, the CPU (2) 102 must change the UI that controls rendering. For instance, in relation to a gauge bar that fast forwards a video playback screen, when the speed of fast forward operation is changed at a gauge position, the gauge position on the UI must be rendered, while changed as required, in synchronism with a position on a finger-touch panel LCD. The shared memory shares these pieces of control data at a high sharing degree. There may be a case where processing performance of the system will significantly increase when the internal shared memory 110 shares the data, to thus control coherence, than when the main storage memory 151 shares the data.

As mentioned above, when UI operation is not performed, processing load on the CPU (1) 101 is light. Since there are very few data shared between the CPU (1) 101 and the CPU (2) 102, the priority level of assignment of the way is low.

Further, when there is no input from the external device, the CPU (1) 101 is in an idle state. In this case, the ways of the shared memory 110 are not assigned (assigned) to the CPU (1) 101, whereupon the ways are released.

In this case, when the user who operates an electronic device commences operation of a touch panel LCD, the CPU (1) 101 restores itself from the idle state by means of an interrupt made by the external device, and immediately processes data input from the external device.

When the memory access 471 is made while (addition of an urgent transfer attribute) the urgent processing attribute is appended to the bus access signal 130 of the CPU (1) 101, the shared memory 110 assigns access from the CPU (1) 101 having an urgent processing attribute to the CPU (1) 101 whose ways have not been thus far assigned to shadow tag memory prepared as tag memory that is not used in normal times.

A hitherto order of priority along which the ways of the shared cache are to be assigned is DSP (2) 104>>HWA (2) 107>DSP (1) 103>CPU (2) 102. The ways of the shared cache are not assigned to the GPU 105, the HWA (1) 106 (a DMA controller), and the CPU (1) 101. For this reason, a tag of an area that has been assigned the way of the CPU (2) 102 having the lowest priority level temporarily locks the way, and a switch is made to the shadow tag.

Some of the clusters 111 of the shared memory 110 used by the CPU (2) 102 are thereby released, to thus enable the CPU (1) 101 to use the thus-released space by way of the shadow tag. Further, when there is no more input from the external device and when the CPU (1) 101 comes into an idle state; namely, when the memory access having the added urgent transfer attribute has completed, the shadow tag is switched to a normal tag. Thus, the way used by the CPU (1) 101 is made available for the CPU (2) 102.

When the shadow tag is switched to the normal tag, there is performed control for instantaneously replacing (flushing) the data on the way in an automatic fashion. When a switch is made to the shadow tag, data with a normal tag still remain. Therefore, when the way lent to the CPU (1) 101 is released, which data must be returned to and written into the CPU (2) 102 are immediately determined by the technique. The shadow tag provides such a mechanism.

As mentioned above, the shared memory system of the second embodiment controls coherence, and hence processing performance of the system significantly increases. Moreover, shared cache can also be assigned even to a master processor that performs processing, like operation of an UI assigned a way at a low priority level.

### Third Embodiment

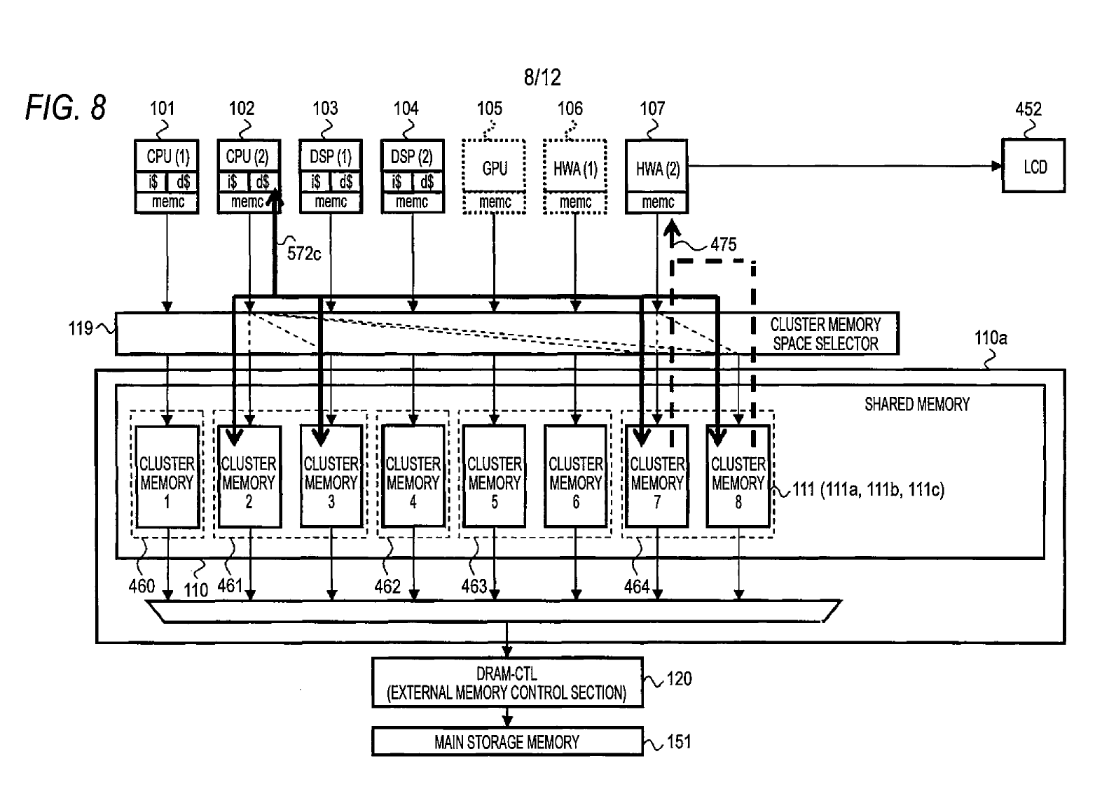

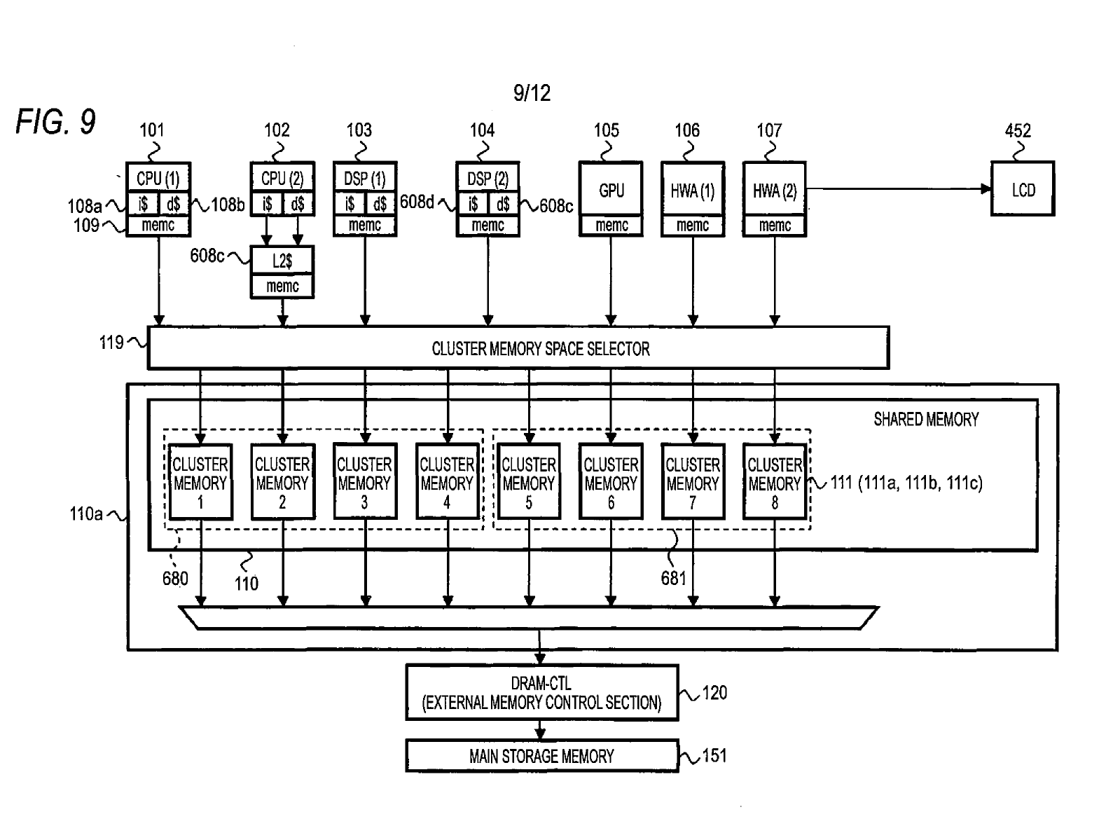

A third embodiment shows a case where there is performed coherence control differing from that described in connection with the second embodiment. FIG. 8 is a schematic showing a configuration of a shared memory system of the third embodiment. Constituent elements that are the same as those described in connection with the first embodiment are assigned the same reference numerals, and their repeated explanations are omitted here for brevity. In the present embodiment, the shared memory system is described as having the shared cache memory configuration 110a. Shared settings of cluster memory of each of the master processors shown in FIG. 9 are substantially identical with those described in connection with the second embodiment.

The third embodiment differs from the second embodiment in that access 572c of the CPU (2) 102 is set on the space 464 made up of the pieces of cluster memory 7 and 8 assigned for the HWA (2) 107 as well as to the space 461 made up of the pieces of cluster memory 2 and 3.

The data for the CPU (2) 102 and the source data for the HWA (2) 107 come thereby into a shared state at all times. After an image has been processed at a work address, the CPU (2) 102 stores the thus-processed data into an address where finally output image data are to be stored. The HWA (2) 107 can share the output image data by means of the shared memory.

As mentioned above, in the shared memory system of the third embodiment, the HWA (2) 107 obviates a necessity to make access to the main storage memory 151 every time. Hence, a band width of the main storage memory 151 is suppressed, and power consumed by access to the main storage memory 151 that is a term dominating power consumption can be curtailed.

### Fourth Embodiment

A fourth embodiment shows a case where an attempt is made to further enhance performance than that achieved in the first embodiment by means of providing a line size differing from that described in connection with the first embodiment and assigning the clusters 111, each of which has an appropriate line size, to contents to be processed.

FIG. 9 is a schematic showing a configuration of a shared memory system of the fourth embodiment. Constituent elements that are the same as those described in connection with the first embodiment are assigned the same reference numerals, and their repeated explanations are omitted here for brevity. In the present embodiment, the shared memory system is described as having the shared cache memory configuration 110a.

The embodiment is based on the assumption that, of the plurality of master processors, the CPU (1) 101 will control the connected peripheral devices; that the CPU (2) 102 will perform processing for displaying a browser; and that the DSP (2) 104 implements a video codec by means of software.

In the present embodiment, each of the CPU (1) 101, the CPU (2) 102, and the DSP (2) 104 is implemented with primary cache.

The CPU (1) 101 has primary caches 108a and 108b and a memory controller 109 and performs control of an external device and I/O control of an LSI. Each of the primary cache (command cache) 108a and the primary cache (data cache) 108b is made up of a line size of 32 bytes.

In the meantime, when compared with the CPU (1) 101, the CPU (2) 102 is a high-performance CPU that operates at a high operating frequency and that is equipped with a core processor which performs a floating-point arithmetic and that is equipped with secondary cache in addition to the primary cache. A line size of secondary cache 608c is 64 bytes.

The DSP (2) 104 is a DSP that can perform codec processing of a video at high throughput and cope with media processing. Primary cache (command cache) 608d and primary cache (data cache) 608e, each of which has a line size of 128 bytes, are provided in the DSP (2) 104.

In the embodiment, a plurality of types of cluster memory groups, including a cluster memory group 680 made up of ways having a line size of 128 bytes and a cluster memory group 681 made up of ways having a line size of 256 bytes, are mixedly present in the pieces of memory 110 shared among the processor cores.

In general, the capacity of cache memory is computed by multiplication of a line size, the number of sets, and the number of ways. As the capacity of the cache memory increases, a cache hit rate increases, so that processor performance can be apparently increased. However, even in the case of a program that exhibits high dependence on a software structure and that exhibits a low hit rate or a comparatively high hit rate, when given memory capacity is exceeded, a cache hit rate is known to exhibit a tendency to become saturated even when memory capacity is increased.

Even when cache memory has constant capacity, cache memory having a larger line size often exhibits a higher hit rate. For instance, particularly in the case of medium data, like an image, the size of one piece of data is comparatively large. Hence, a cache hit is often accomplished efficiently when one line size is large.

The present embodiment utilizes such a characteristic, and the access monitoring mechanism 112 supervises an attribute of access. For instance, in the case of browser rendering data handled by the CPU (2) 102 and frame data for which the DSP (2) 104 accesses the pieces of shared memory 110, a line size control section 118 performs control for preferentially mapping a cluster 111 having a larger line size.

In the meantime, if access like, a mishit pertaining to a primary data cache of the CPU (1) 101 and a mishit pertaining to a primary command cache of the CPU (1) 101 and CPU (2) 102, is assigned to the clusters 111 formed in a large line size when access is made to the shared memory 110, there may also be many cases where a hit and a mishit will coexist in the same line. As a consequence, an increase occurs in the number of useless data accesses, which will arouse a concern about occurrence of a problem like an increase in operating current and a decrease in latency of a processor, which would otherwise be caused by access to the shared memory 110.

In the embodiment, the access monitoring mechanism 112 performs control for assigning access having such a characteristic preferentially to cluster memory having a small way.

The shared memory system of the fourth embodiment can assign the cluster 111 having a line size appropriate for processing specifics, thereby enhancing performance further.

In a case where the pieces of cluster memory 111 are shared among a small number of master processors; where processing performance of a processor tends to become saturated against shared memory capacity even when the size of shared memory is increased; or where only a single master processor makes access to the pieces of cluster memory 111, the shared memory system can also be configured as follows. Specifically, the shared memory system can also be configured so as to have any one or two or more functions (power control functions), such as a clock control function for designating some of the pieces of cluster memory 111 to an area that is not previously assigned any master processors, to thus inhibit clock operation; a power shutoff function for turning off an on-chip switch provided in an LSI; and a leak current inhibition function for decreasing a memory voltage while memory contents are retained. Application of such a function makes it possible to enhance power performance.

### Fifth Embodiment

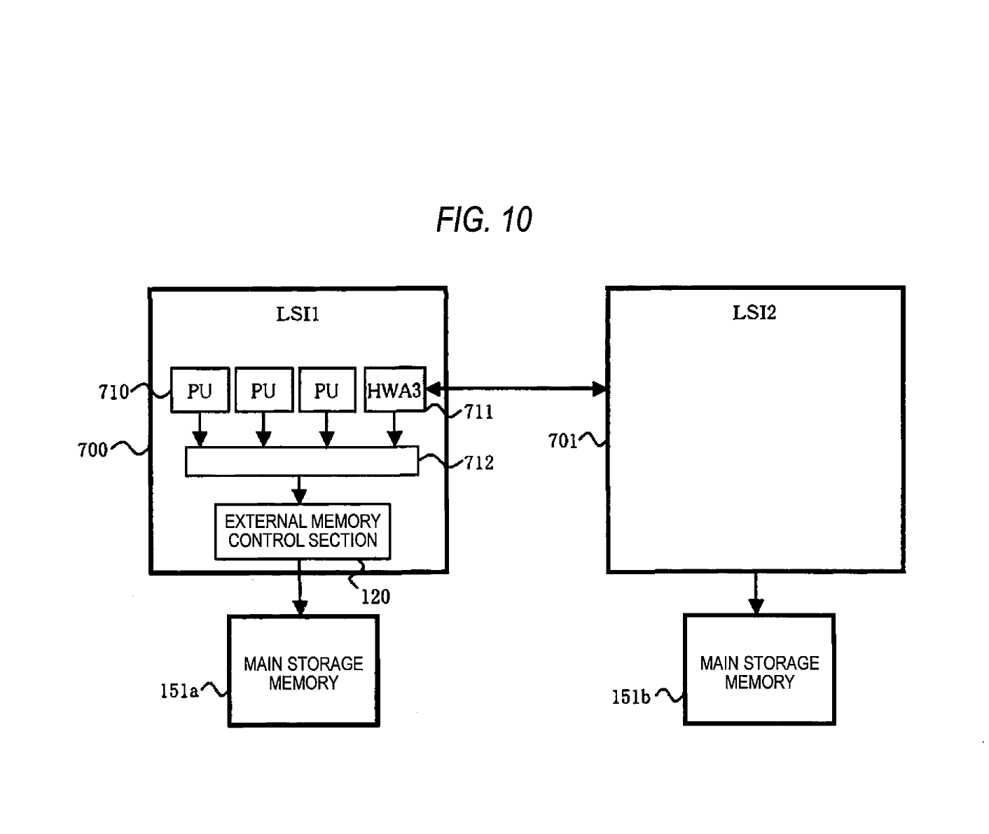

FIG. 10 is a schematic showing a configuration of a shared memory system of a fifth embodiment. The shared memory system of the fifth embodiment is embodied as a system in which a system LSI (2) 701 expansion connected to the outside as a companion with respect to an application processor LSI (1) 700 (a semiconductor device) provided with an asymmetric multiprocessor shares, as a master processor of the shared memory system; namely, an HWA (3) 711, shared memory 712 along with a processor unit 710.

By virtue of such a configuration, memory access made by the LSI (2) 701 is taken in the LSI (1) 700 as memory access made by the HWA 3 (711) that is one of the master processors. Therefore, there can be adopted a configuration that assures coherence between the LSI (1) 700 and the LSI (2) 701. Further, main storage memory 151b connected to the LSI (2) 701 can also be omitted.

The shared memory system of the fifth embodiment makes it possible to curtail the number of pieces of main storage memory 151a and 151b (see FIG. 10) provided in the respective LSIs and cut power consumption while assuring performance. Moreover, costs of electronic devices can be reduced.

The embodiments described this time are merely illustrative in all respects and should not be construed as being restrictive. A scope of the present invention is provided by claims rather than by the above descriptions. All alterations are intended to fall within the scope of the present invention from the viewpoints of meanings and a scope equivalent to the claims.

Although the present invention has been described in detail and by reference to the specific embodiments, it is manifest to those skilled in the art that the present invention be susceptible to various alterations or modifications without departing the spirit and scope of the present invention.

The present patent application is based on Japanese Patent Application (JP-2010-161797) filed on Jul. 16, 2010, the entire subject matter of which is incorporated herein by reference.

The present invention is useful as a memory system, or the like, having shared memory that is accessed by a plurality of master processors and that can shorten a processing time and curtail power consumption.

What is claimed is:

1. A shared memory system, comprising:
a plurality of master processors;
a shared memory accessed by the plurality of master processors and divided into a plurality of clusters;
an assignment section that assigns access from the master processors to a plurality of cluster spaces, the cluster spaces each including at least one of the plurality of clusters and configured of any one of a space shared among all of the master processors, a space shared among a plurality of specific master processors, and a space occupied by a single master processor; and
an alteration section that alters configuration of the cluster spaces based on an attribute information about the plurality of master processors.

2. The shared memory system according to claim 1, wherein each of the master processors includes a central processor, a digital signal processor, a general purpose graphics processor, or a hardware accelerator.

3. The shared memory system according to claim 1, wherein the attribute information is added to an access signal from each of the master processors and includes at least one of a master identification attribute, a read/write attribute, an address attribute, a data/command attribute, a secure attribute, a cache/non-cache attribute, and a transfer attribute.

4. The shared memory system according to claim 1, wherein the shared memory includes a cache memory, and wherein there is provided with a clock control section that, when a mishit has occurred in one of the cluster spaces, decreases an operation clock frequency of a master processor for which access is assigned to the one of the cluster spaces during refilling operation or halts the operation clock of the master processor.

5. The shared memory system according to claim 1, further comprising an access monitoring section that determines attribute information about the master processors and that permits the master processors to access to the cluster spaces.

6. The shared memory system according to claim 5, further comprising a scheduling section that stores accesses to the cluster spaces from the master processors; and an access policy control section that controls the accesses to the cluster spaces stored by the scheduling section;
wherein the access monitoring section determines the attribute information about the master processors and passes the attribute information to the scheduling section, and the access policy control section notifies a policy to the scheduling section and permits making of access to a cluster space corresponding to the attribute information.

7. The shared memory system according to claim 6, wherein the access policy control section changes a content of a priority setting register on which a priority level of access to the cluster space is set.

8. The shared memory system according to claim 6, further comprising an integration section that integrates the accesses from the master processors to the cluster spaces stored by the scheduling section.

9. The shared memory system according to claim 6, wherein the shared memory includes a cache memory, and wherein there is provided with an urgent transfer attribute addition section that adds an urgent transfer attribute to access from the master processors to the cluster space; and wherein the access policy control section lends an area of the cluster spaces, which can be given up, to an access from a master processor having the added urgent transfer attribute.

10. The shared memory system according to claim 9, wherein, when the access from the master processor having the added urgent transfer attribute completes, the cluster space with the lent area is restored to an original state.

11. The shared memory system according to clam 1, wherein the shared memory includes a cache memory, the plurality of cluster spaces are configured of cluster spaces having different line sizes, there is provided a line size control section that sorts the access from each of the master processors to the cluster space having a line size commensurate with a content of processing of the master processor.

12. The shared memory system according to claim 1, further comprising a power control section that blocks a power supply to a specific cluster space or that hinders a leakage current.

13. The shared memory system according to claim 1, wherein the shared memory system is configured of a semiconductor device and is connected as a master processor to another semiconductor device.

14. A shared memory system control method for a shared memory system having a plurality of master processors and a shared memory that is accessed by the plurality of master processors and that are divided into a plurality of clusters, the method comprising:
an assignment step of assigning access from the master processors to the cluster spaces, the cluster spaces each including at least one of the plurality of clusters and configured any one of a space shared among all of the master processors, a space shared among a plurality of specific master processors, and a space occupied by a single master processor;
an alteration step of altering configuration of the cluster spaces based on attribute information about the master processors.
